(19) United States
(12) Patent Application Publication
(10) Pub. No.: US 2025/0162593 A1
(43) Pub. Date: May 22, 2025

(54) ENERGY CONSUMPTION ESTIMATION DEVICE

(71) Applicant: DENSO CORPORATION, Kariya-city (JP)

(72) Inventors: Ryota SHIMADA, Kariya-city (JP); Hiroyuki NANJO, Kariya-city (JP); Noriaki IKEMOTO, Kariya-city (JP)

(73) Assignee: DENSO CORPORATION, Kariya-city (JP)

(21) Appl. No.: 18/946,501

(22) Filed: Nov. 13, 2024

(30) Foreign Application Priority Data
Nov. 20, 2023 (JP) 2023-196772

(51) Int. Cl. B60W 40/06; B60W 40/10; B60W 40/13; G01C 21/34

(52) U.S. Cl. CPC B60W 40/06; B60W 40/1005; B60W 40/13; G01C 21/3469; B60W 2540/12

(57) ABSTRACT

An energy consumption estimation device is provided for estimating energy consumption of a vehicle that travels on a road surface. The energy consumption estimation device includes a water information acquisition unit configured to acquire water-related information on a water-related substance on the road surface, and an energy estimation unit configured to estimate the energy consumption of the vehicle that travels on the road surface based on the water-related information acquired by the water information acquisition unit.

### CROSS-REFERENCE TO RELATED APPLICATION

This application is based on and claims the benefit of priority from earlier Japanese Patent Application No. 2023-196772 filed Nov. 20, 2023, the description of which is incorporated herein by reference.

### BACKGROUND

### Technical Field

This disclosure relates to an energy consumption estimation device.

### Related Art

Conventionally, an energy estimation device is known that calculates energy consumption of a vehicle when traveling a scheduled route based on a speed pattern, travel resistance, and vehicle characteristics. This energy estimation device calculates the travel resistance for calculating the energy consumption using the vehicle characteristics, an output value acquired by detecting a driving source of the vehicle, a braking value acquired by detecting a braking force of the brake, and a vehicle speed acquired by detecting a speed of the vehicle.

### BRIEF DESCRIPTION OF THE DRAWINGS

In the accompanying drawings:

FIG. 1 is a schematic diagram of an energy consumption estimation device according to one embodiment;

FIG. 2 is a flowchart of a control process performed by the energy consumption estimation device;

FIG. 3 is an illustration of an example of changes with time in travel speed during travel on a travel-scheduled road;

FIG. 4 is a schematic diagram of an electric vehicle subject to energy consumption estimation;

FIG. 5 illustrates an example of the correlation between energy transmission coefficient and transmission energy of an electric system;

FIG. 6 is a schematic diagram of an engine vehicle subject to energy consumption estimation;

FIG. 7 is an illustration of an example of the correlation between engine efficiency and engine power;

FIG. 8 is an illustration of an example of energy consumption that increases as a traveled distance increases;

FIG. 9 is an illustration of an example of a difference between travel resistance when there is a water-related substance on a road and travel resistance when the road is dry;

FIG. 10 is an illustration of an example of state transitions of a water-related substance;

FIG. 11 is an illustration of an example of a two-dimensional map for determining a water resistance coefficient; and

FIG. 12 is an illustration of an example of a two-dimensional map for determining an amount of increase in travel resistance due to snow squash.

### DESCRIPTION OF SPECIFIC EMBODIMENTS

According to the diligent research of the inventors, the travel resistance of the vehicle when travelling on a road surface changes depending on a road surface condition, such as an amount of snow deposited on the road surface or an amount of rainfall on the road surface. Thus, the energy consumption varies as the travel resistance changes depending on the road surface condition. However, the above known energy estimation device, as described in JP 2015-030327 A, does not take into account the road surface condition when calculating the energy consumption. Thus, when the road surface condition changes, such as when snow is deposited on the road or when it is raining, there is likely to be an error in the energy consumption calculated.

In view of the foregoing, it is desired to have an energy consumption estimation device capable of accurately calculating the energy consumption.

One aspect of the present disclosure provides an energy consumption estimation device for estimating energy consumption of a vehicle that travels on a road surface. The energy consumption estimation device includes a water information acquisition unit configured to acquire water-related information on a water-related substance on the road surface, and an energy estimation unit configured to estimate the energy consumption of the vehicle that travels on the road surface based on the water-related information acquired by the water information acquisition unit.

When there is a water-related substance on the road surface, the resistance when the vehicle is traveling on the road surface becomes higher than when there is no water-related substance on the road surface. Thus, when there is a water-related substance on the road surface, the energy consumption varies as compared to when there is no water-related substance on the road surface.

According to the above configuration, the energy estimation unit estimates the energy consumption based on the water-related information, which enables suppression of calculation errors in energy consumption caused by the presence of the water-related substance. Therefore, the energy consumption estimation device is capable of accurately calculating the energy consumption.

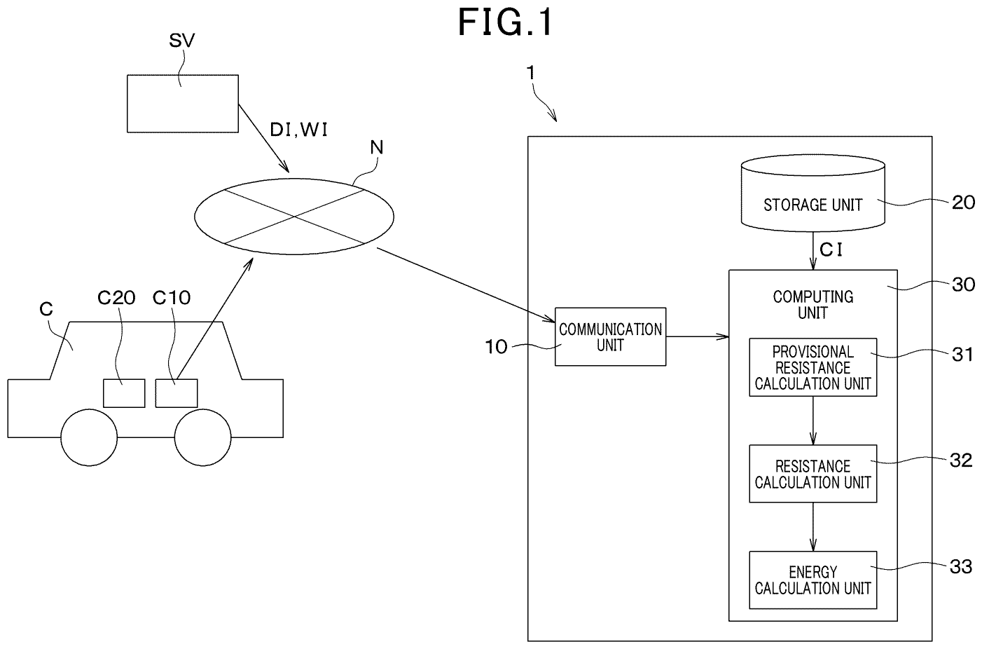

The energy consumption estimation device 1 according to the present embodiment will now be described with reference to FIGS. 1 to 12. As illustrated in FIG. 1, the energy consumption estimation device 1 of the present embodiment is configured to be connectable to a vehicle C and a server SV, which is an external device located outside the energy consumption estimation device 1, via a network N. The energy consumption estimation device 1 is a device that estimates energy consumption when the vehicle C travels based on various items of information acquired from the server SV and the vehicle C via the network N. Although only one vehicle C is illustrated in FIG. 1 for illustration purposes, it may be assumed that the vehicle C is any one of a plurality of vehicles C to which the present disclosure is applicable.

The server SV is a communication device that communicates with the energy consumption estimation device 1 via the network N. The server SV is configured as a computer that includes a communication unit, a storage unit, a computing unit, and other components, although not shown. The communication unit is a network interface for connecting to the network N and communicating with other devices via the network N. The storage unit is a memory that stores the programs to be executed by the computing unit and information to be transmitted to the energy consumption estimation device 1. The storage unit includes a volatile storage medium and a non-volatile storage medium, and stores in the non-volatile storage medium the programs to be executed by the computing unit and the information to be transmitted to the energy consumption estimation device 1.

The storage unit stores, for example, travel route information DI on a travel route of the vehicle C and weather information WI on weather on the travel route of the vehicle C, as information necessary for the energy consumption estimation device 1 to estimate the energy consumption. Details of the travel route information DI and the weather information WI will be described later. The computing unit performs processes corresponding to the programs stored in the non-volatile storage medium by executing those programs. During execution of the programs, the computing unit writes data to the volatile and non-volatile storage media, reads data from the volatile and non-volatile storage media, and communicates with other devices using the communication unit, as necessary.

The vehicle C is, for example, any one of motorised vehicles. Specifically, the motorised vehicles may include an electric vehicle as well as a plug-in hybrid vehicle, a hybrid vehicle, and a fuel cell vehicle. However, the vehicle C may be an engine vehicle. The electric vehicle is a vehicle equipped with an electric motor driven solely by electricity supplied from a battery as a drive source. The hybrid vehicle is a vehicle equipped with a combustion engine and an electric motor as drive sources. The engine vehicle is a vehicle equipped only with a combustion engine as a drive source and driven by a fuel such as petrol or diesel oil.

The vehicle C may be a passenger car, a truck, a bus, or any type of vehicle that can travel on the road. The passenger car may be an owner-driven car owned by an individual, a taxi, a shared car, a rented car, or the like. The taxi is a vehicle used for the service of transporting passengers to a given destination location for a fee. The shared car is a vehicle used for car-sharing services. The rental car is a vehicle used for vehicle rental services. The truck is a freight vehicle that transports freight to a given destination location. The destination of the truck is, for example, the same location repeatedly or a different location for each transportation. The bus is a large passenger vehicle that transports passengers at a fixed fare by operating on a predefined route. The vehicle C, which is subject to energy consumption estimation by the energy consumption estimation device 1, may hereinafter be referred to as a subject vehicle. Vehicles that are different from the vehicle C for which the energy consumption is estimated by the energy consumption estimation device 1 may be referred to as other vehicles.

The vehicle C includes a vehicle communication unit C10 and sensors C20, as illustrated in FIG. 1. The vehicle communication unit C10 is a communication unit for communicating with the server SV and the energy consumption estimation device 1 via the network N. The vehicle communication unit C10 is configured to receive detection signals of the sensors C20 by communicating with the sensors C20 mounted to the vehicle C via an on-board network of the vehicle C.

The sensors C20 are a group of sensors mounted to the vehicle C to acquire information related to the vehicle C. The sensors C20 include, for example, an air pressure sensor that detects air pressures of the tires, a speed sensor that detects the speed of the vehicle C, an acceleration sensor that detects the acceleration of the vehicle C, and a driving force sensor that detects the driving force of the vehicle C. The sensors C20 may further include a brake sensor that detects the braking force of the vehicle C, surroundings monitoring sensors that monitor surroundings of the vehicle C and detect objects around the vehicle C.

The air pressure sensor detects air pressures of the tires and transmits a detection signal corresponding to the detected air pressures to the vehicle communication device C10. The speed sensor detects the vehicle speed and transmits a detection signal corresponding to the detected speed to the vehicle communication device C10. The acceleration sensor detects the acceleration of the vehicle C and transmits a detection signal corresponding to the detected acceleration to the vehicle communication device C10. The driving force sensor detects the driving force of the vehicle C and transmits a detection signal corresponding to the detected driving force to the vehicle communication device C10. The brake sensor detects the braking force of the vehicle C and transmits a detection signal corresponding to the detected braking force to the vehicle communication device C10.

Surroundings monitoring sensors may include, for example, cameras that capture images of the surroundings, sonars that output ultrasonic waves to detect surrounding objects, a millimeter-wave radar that outputs millimeter waves to detect surrounding objects, and Light Detection and Ranging (LiDAR) that outputs laser beams to detect surrounding objects.

Various items of information detected by the sensors C20 are transmitted via the network N to the server SV and the energy consumption estimation device 1.

The energy consumption estimation device 1 of the present embodiment is not limited to any type of vehicle and is configured to be able to estimate a predictive value of energy consumption of the vehicle C before traveling of the vehicle C, based on the various items of information acquired from the server SV and the vehicle C via the network N.

The energy consumption estimation device 1 is configured as a computer including a communication unit 10, a storage unit 20, a computing unit 30, and other components. The communication unit 10 is a network interface for connecting to the network N and communicating with the server SV and the vehicle C via the network N. The storage unit 20 is a memory that stores programs to be executed by the computing unit 30 and the vehicle characteristics information CI, which is information necessary for estimating the energy consumption. The storage unit 20 includes a volatile storage medium and a non-volatile storage medium, and stores in the non-volatile storage medium programs to be executed by the computing unit 30 and the vehicle characteristics information CI. Details of the vehicle characteristics information CI will be described later.

The computing unit 30 implements various processes by executing the programs stored in the non-volatile storage medium. During execution of these processes, the computing unit 30 uses the volatile storage medium as a workspace and carries out reading from and writing to the non-volatile storage medium. In addition, during execution of these processes, the computing unit 30 acquires the travel route information DI, weather information WI, and vehicle characteristics information CI, which are necessary for estimating the energy consumption.

The computing unit 30 includes a provisional resistance calculation unit 31, a resistance calculation unit 32, and an energy calculation unit 33, for performing various processes, as illustrated in FIG. 1. The provisional resistance calculation unit 31 calculates a provisional travel resistance VFdrv, as will be described later. The resistance calculation unit 32 calculates a travel resistance Fdrv, as will be described later. The energy calculation unit 33 calculates the energy consumption based on the travel resistance Fdrv calculated by the resistance calculation unit 32, the travel route information DI, weather information WI, and vehicle characteristics information CI, as acquired. The computing unit 30 of the present embodiment functions as an energy estimation unit.

The computing unit 30 performs a control program stored in the storage unit 20, and thereby functions as the provisional resistance calculation unit 31, the resistance calculation unit 32, and the energy calculation unit 33. In an alternative, the computing unit 30 may include a plurality of circuit modules respectively corresponding to the provisional resistance calculation unit 31, the resistance calculation unit 32, and the energy calculation unit 33. The processes to be performed by the provisional process calculation section 31, the resistance calculation section 32, and the energy calculation section 33 will now be described as processes to be performed by the computing unit 30.

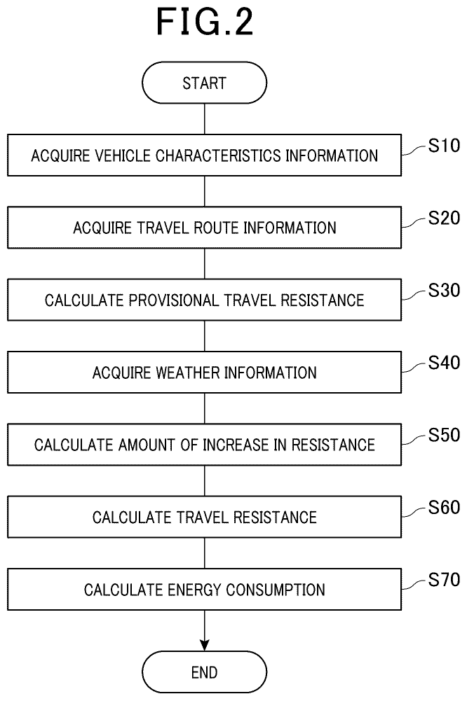

Next, an example of a control process performed by the computing unit 30 of the energy consumption estimation device 1 configured as above will now be described with reference to the flowchart illustrated in FIG. 2. The control process illustrated in FIG. 2 is performed, for example, when the travel-scheduled road that the vehicle C is scheduled to travel from an origination location to a destination location is set by an operator, and the operation to initiate the energy consumption estimation process of calculating the energy consumption for the vehicle C to travel on the travel-scheduled road is performed.

First, at step S10, the computing unit 30 acquires the vehicle characteristics information CI from the storage unit 20 of the energy consumption estimation device 1. The vehicle characteristics information CI includes, as information indicating the characteristics of the subject vehicle, information on the gross vehicle weight W (e.g., 2000 kg, etc.) indicating the weight of the subject vehicle, and information on the air resistance coefficient Cd (e.g., 0.3, etc.) indicating the coefficient of air resistance that the subject vehicle receives when traveling. The vehicle characteristics information CI also includes information on the front projected area A (e.g., 5 m²) indicating the projected area of the subject vehicle as viewed from the front to the rear of the vehicle, and information on the rolling resistance coefficient u (e.g., 0.01) indicating the rolling resistance coefficient of the subject vehicle when traveling on the road surface. The computing unit 30 of the present embodiment functions as a vehicle information acquisition unit that acquires the vehicle characteristics information CI. The vehicle characteristics information CI includes information on the tire contact area Tc (e.g., 0.02 m²) that indicates the contact area of the tires.

The storage unit 20 of the energy consumption estimation device 1 pre-stores the vehicle characteristics information CI corresponding to each of all the vehicles C subject to energy consumption calculation. The vehicle characteristics information CI may be set in the storage unit 20 via an input operation by an operator, or may be acquired from an external device such as the server SV.

Subsequently, as step S20, the computing unit 30 acquires the travel route information DI from the server SV via the communication unit 10. The storage unit of the server SV pre-stores map information including the travel route information DI. This map information includes the travel route information DI, which includes various items of information about the travel route set by the operator on which the vehicle C is scheduled to travel. Specifically, the travel route information DI includes information about the travel-scheduled road set by the operator, as information about scheduled locations that the vehicle C is scheduled to pass through. The information about the travel-scheduled road includes route information from the origination location to the destination location, road slope information for the travel-scheduled road, and information about an elapsed time t since the vehicle departed from the origination location. The information about the travel-scheduled road also includes information on the estimated travel speed V at the elapsed time t and the estimated acceleration a at the elapsed time t when traveling on the travel-scheduled road. The communication unit 10 of the present embodiment functions as a location information acquisition unit that acquires the travel route information DI corresponding to scheduled location information.

In addition, the information about the travel-scheduled road includes information on the traffic volume Rt, which indicates the traffic volume on the travel-scheduled road of the subject vehicle. Furthermore, the travel route information DI includes information on the traffic flow rate Rs, which indicates the speeds of other vehicles, and information on the road surface type Rk, which indicates the type of road surface on which the subject vehicle is scheduled to travel. The information on the traffic volume Rt is information on the number of other vehicles passing on the travel-scheduled road per unit time, and is set based on, for example, information on the history of the number of other vehicles that have passed on the travel-scheduled road. The traffic volume Rt is set, for example, to 100 vehicles per hour.

The information on the traffic flow speed Rs is, for example, information on the average vehicle speed of other vehicles on the travel-scheduled road, and is set based on, for example, the history of the vehicle speeds of other vehicles that have passed on the travel-scheduled road. The traffic flow speed Rs is set, for example, to 40 km/h. In addition, the traffic flow speed Rs may be set based on information other than the history of the vehicle speeds of other vehicles, and may be set based on the legal speed, for example.

The information on the road surface type Rk is, for example, information on the type of road surface of the travel-scheduled road, which indicates a material that covers the road surface (e.g. asphalt, concrete, gravel, soil, steel plate). In a case where the material that covers the road surface of the travel-scheduled road is formed of asphalt, the information on the road surface type Rk includes information on the number of years that have elapsed since the travel-scheduled road was constructed. In a case where the travel-scheduled road formed of asphalt is relatively old, the road surface type Rk includes old asphalt information indicating that the road formed of asphalt is relatively old. In the case of the road surface type Rk including the old asphalt information, the old asphalt information includes information indicating that the road surface condition of the travel-scheduled road has changed due to aging. In a case where the travel-scheduled road formed of asphalt is relatively new, the road surface type Rk includes new asphalt information indicating that the travel-scheduled road is relatively new. In the case of the road surface type Rk including the new asphalt information, the new asphalt information includes information indicating that the shape of the travel-scheduled road has changed little due to aging.

The map information that includes the travel route information DI may be pre-stored in the storage unit 20 of the energy consumption estimation device 1. In this case, the computing unit 30 acquires the travel route information DI from the storage unit 20.

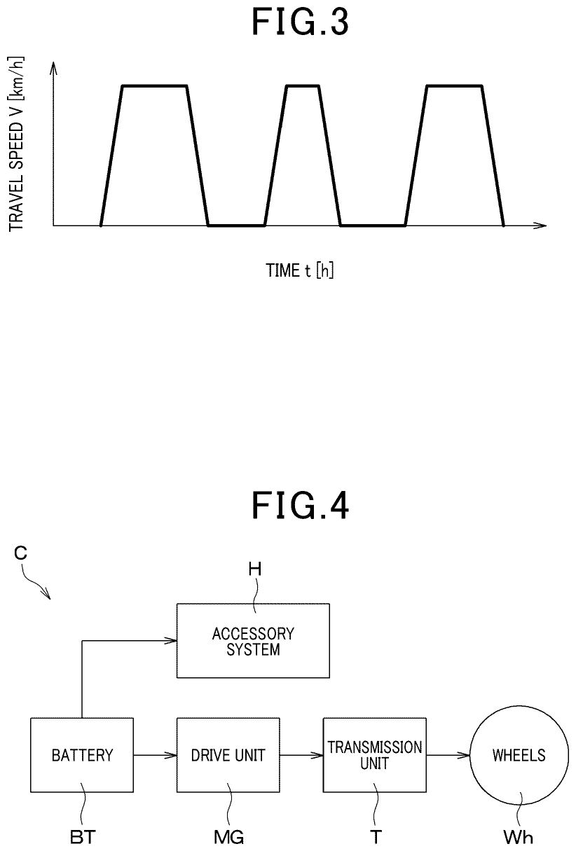

The energy consumption estimation device 1 calculates an estimate of the energy consumption of vehicle C using the acquired vehicle characteristics information CI and travel route information DI. For example, it is supposed that the operator sets the origination location and destination location of the vehicle C, and also sets the travel speed V for traveling on the travel-scheduled road from the origination location to the destination location, as illustrated in FIG. 3. The energy consumption estimation device 1 calculates a prediction of the energy consumption before traveling based on the elapsed time t and the travel speed V at the elapsed time t. FIG. 3 illustrates an example of the elapsed time t and the travel speed V at the elapsed time t during travel of the vehicle C is traveling on a travel-scheduled road.

It should be noted that the method for calculating the energy consumption differs depending on whether the vehicle C is an electric vehicle driven by an electric motor or an engine vehicle driven by a combustion engine. Therefore, the method will now be described for calculating the energy consumption in the case where the vehicle C is an electric vehicle configured as illustrated in FIG. 4.

As illustrated in FIG. 4, the vehicle C includes a battery BT that stores electrical power, a power unit MG that includes an electric motor that serves as the drive source for driving the vehicle C, a transmission unit T that transmits the power output from the power unit MG to the wheels Wh, and an accessory system H.

The power unit MG operates using the power supplied from the battery BT, and includes a step-up converter (not shown) that increases the voltage supplied from the battery BT, and an inverter (not shown) that supplies power to the electric motor. The transmission unit T includes a transmission (not shown) that adjusts the power output from the electric motor. The accessory system H includes an air conditioner and accessories. The energy consumption of an electric vehicle having such a configuration may be calculated using Equation (1), which is a function of the elapsed time t as expressed below.

$$Etotal\_prod \_base ( t ) = Edrv\_prod \_base ( t ) + Eother\_prod \_base ( t ) \qquad ( 1 )$$

In Equation (1), Etotal_prd_base(t) indicates an estimate of the energy consumption for a predefined elapsed time t by the electric vehicle C when traveling along the travel-scheduled road. Edrv_prod_base(t) in Equation (1) is an estimate of driving energy consumption for the elapsed time t by the power unit MG including the electric motor. Eother_prd_base indicates an estimate of the energy consumption other than the driving energy consumption for the elapsed time t.

Energy other than energy consumed as driving energy is the energy consumed in the auxiliary system H. Specifically, it is the energy consumed by operations of the air-conditioner and the total energy consumed by the operations of the accessories. That is, the energy consumption Etotal_prd_base is the total energy consumption acquired by summing the driving energy consumed by the power unit MG including the electric motor, Edrv_prd_base, and the energy consumed in the accessory system H, Eother_prd_base.

When the total energy consumption Etotal_prd_base is negative, the total energy consumption Etotal_prd_base is supplied to the battery BT as regenerative energy and stored as electrical power.

The accessory system energy Eother_prd_base in Equation (1) may be calculated according to Equation (2), which is a function of the elapsed time t as expressed below.

$$Eother\_prd \_base = Σ ( P o t h e r ( t ) ▪ ( t - ( t - 1 ) ) \qquad ( 2 )$$

Pother (t) in Equation (2) is the energy consumption of the accessory system H at each elapsed time t. The energy Pother is pre-set to a fixed value, such as 5 kW, for example. As illustrated in Equation (2), the energy of the accessory system Eother_prd_base is calculated by integrating the energy consumption at each elapsed time t other than the driving energy consumption for driving the vehicle C, that is, the energy consumption of the accessory system H at each elapsed time t.

The driving energy Edrv_prd_base in Equation (1) may be calculated according to Equation (3), which is a function of the elapsed time t as expressed below.

$$Edrv\_prd \_base = Σ ( {P}^{″} drv ( t ) ▪ ( t - ( t - 1 ) ) \qquad ( 3 )$$

P″drv(t) in Equation (3) is the energy consumption of the power unit MG at each elapsed time t. As illustrated in Equation (3), the driving energy Edrv_prd_base is calculated by integrating the driving energy consumption at each elapsed time t for driving the vehicle C.

The energy P″drv in Equation (3) may be calculated according to the following Equation (4) and Equation (5), which are functions of the elapsed time t.

$${P}^{″} drv ( t ) = {P}^{′} drv ( t ) / Relec \qquad ( 4 )$$

$${P}^{″} drv ( t ) = {P}^{′} drv ( t ) / Rmech \qquad ( 5 )$$

Pdrv(t) in Equation (5) is driving horsepower required at each elapsed time t to drive the vehicle C at the travel speed V P′drv(t) in Equation (4) and Equation (5) is transmission energy required at each elapsed time t to be output from the transmission unit T for driving the vehicle C at the travel speed V Relec in Equation (4) indicates the transmission coefficient of the electrical system energy in the power unit MG. Rmech in Equation (5) indicates the transmission coefficient of the mechanical system energy in the transmission unit T.

The transmission coefficient of the electrical system energy, Relec, may be determined, for example, using a predefined correlation map between the transmission coefficient Relec and the transmission energy P′drv, as illustrated in FIG. 5. In other words, the transmission coefficient of the electrical system energy, Relec, may be determined from the correlation map illustrated in FIG. 5 and the transmission energy P′drv. The transmission coefficient of the mechanical system energy, Rmech, is predetermined with a fixed value, e.g. 70%.

As described above, the estimate of the energy consumption of the electric vehicle when travelling on the travel-scheduled road may be determined using Equation (1) to Equation (5).

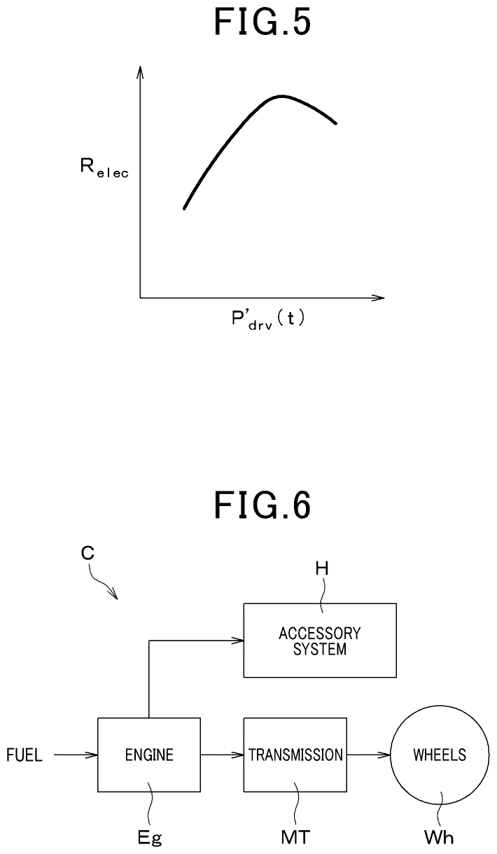

Subsequently, the method of calculating the energy consumption will now be described in the case of the vehicle C being an engine vehicle having the configuration illustrated in FIG. 6.

As illustrated in FIG. 6, the vehicle C includes an engine Eg that serves as the driving source for driving the vehicle C, a transmission MT that transmits the power output from the engine Eg to the wheels Wh, and an accessory system H.

The engine Eg operates using supplied fuel, and includes injectors (not shown) that inject the supplied fuel and ignitors (not shown) that ignite the injected fuel. The transmission MT includes a plurality of gears (not shown) that adjust the power output from the engine Eg and transmit it to the wheels Wh. The accessory system H includes the air conditioner and accessories described above, as in the case of the electric vehicle. The energy consumption of the engine vehicle having such a configuration may be calculated according to Equation (6), which is a function of the elapsed time t as expressed below.

$$Etotal\_prd \_base ( t ) = Σ ( {P}^{′} sum ( t ) ▪ ( t - ( t 1 ) ) ) \qquad ( 6 )$$

Etotal_prod_base in Equation (6) indicates an estimate of the energy consumption of the engine vehicle C for an elapsed time t when traveling along the travel-scheduled road. P′sum(t) in Equation (6) is the total energy consumption of the engine Eg for driving the vehicle C at each elapsed time t. As expressed in Equation (6), the energy consumption Etotal_prod_base is calculated by integrating the energy consumption of the engine Eg at each elapsed time t for driving the vehicle C.

In addition, the total energy P′sum in Equation (7) may be calculated using Equation (7), which is a function of the elapsed time t as expressed below.

$${P}^{′} sum ( t ) = Psum ( t ) / Reng \qquad ( 7 )$$

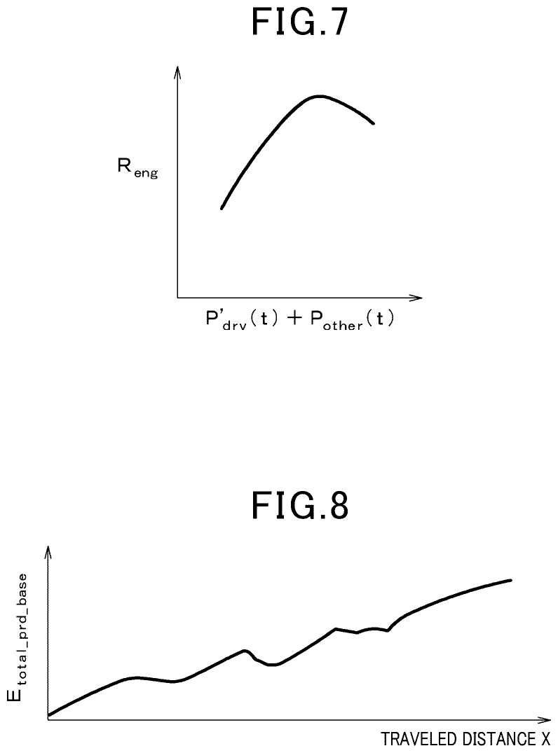

Psum(t) in Equation (7) is the engine power required at each elapsed time t for driving the vehicle C at a travel speed V. Reng in Equation (7) indicates the engine efficiency when the engine Eg outputs power using the supplied fuel. The engine efficiency Reng may be calculated using a correlation map that predefines the correlation between the engine efficiency Reng as illustrated in FIG. 7 and the engine power Psum acquired from P′drv(t)+Pother(t) according to Equation (8) below. In other words, the engine efficiency Reng may be determined from the correlation map illustrated in FIG. 7 and the engine power Psum. The engine power Psum may be calculated according to Equation (8), which is a function of the elapsed time t as expressed below.

$$Psum ( t ) = {P}^{′} drv ( t ) + P o t h e r ( t ) \qquad ( 8 )$$

P′drv(t) in Equation (8) is the power transmitted to the transmission (MT), among the power output from the engine Eg at elapsed time t. Pother(t) in Equation (8) is the power transmitted to the accessory system H at elapsed time t. The power Pother is pre-set to a fixed value, for example, 5 kW. As expressed in Equation (8), the engine power Psum may be acquired by summing the power transmitted to the transmission MT and the power transmitted to the accessory system H.

The power P′drv transmitted to the transmission MT may be calculated using Equation (9), which is a function of the elapsed time t as expressed below.

$${P}^{′} drv ( t ) = Pdrv ( t ) / Rmech \qquad ( 9 )$$

Pdrv(t) in Equation (9) is driving horsepower at each elapsed time t required to drive the vehicle C at the required travel speed V. Rmech in Equation (9) indicates the transmission coefficient of the mechanical system energy in the transmission MT.

The transmission coefficient of the mechanical system energy, Rmech, is pre-set to a fixed value, for example, 70%, as in the case of the vehicle C being an electric vehicle.

As described above, the estimate of the energy consumption of the engine vehicle when traveling along the travel-scheduled road may be calculated using above Equations (6) to (9).

The energy consumption of the electric vehicle, Etotal_prd_base, and the energy consumption of the engine vehicle, Etotal_prd_base, calculated using the above equations, increase as the traveled distance X of the vehicle C increases, as illustrated in FIG. 8.

By the way, the driving horsepower Pdrv in Equation (5) and the driving horsepower Pdrv in Equation (9) may be calculated using the travel resistance Fdrv and the travel speed V at the elapsed time t, as expressed in Equation (10) which is a function of the elapsed time t.

$$Pdrv ( t ) = Fdrv ( t ) ▪ V ( t ) \qquad ( 10 )$$

Fdrv(t) in Equation (10) is an estimate of the travel resistance generated when the vehicle C travels on the surface of the travel-scheduled road at elapsed time t, and includes various resistance components such as air resistance and rolling resistance.

The travel resistance Fdrv in Equation (10) may be calculated using Equation (11) which is a function of the elapsed time t, as expressed below.

$$Fdrv ( t ) = Wa ( t ) + 0.5 ▪ρ▪ Cd ▪ {Av}^{2} ( t ) + u W g + Wg sin θ ( t ) \qquad ( 11 )$$

In Equation (11), W is the gross vehicle weight, a(t) is the acceleration at elapsed time t, ρ is the air density, Cd is the air resistance coefficient, A is the entire surface projected area, V(t) is the vehicle speed at elapsed time t, u is the rolling resistance coefficient, and g is the acceleration of gravity. In addition, sin θ(t) indicates the slope of the travel-scheduled road between the predicted location of the subject vehicle at time t and the predicted location of the subject vehicle at time t−1.

Information on the gross vehicle weight W, information on the air resistance coefficient Cd, information on the front projected area A, and information on the rolling resistance coefficient u are included in the vehicle characteristics information CI, and are information that causes the travel resistance Fdrv to change. In addition, information on the acceleration a, information on the travel speed V, and information on the slope of the travel-scheduled road are information included in the travel route information DI.

Information on the air density p and the acceleration of gravity g is pre-set in the computing unit 30. The air density ρ may be pre-set to a fixed value, for example 1.293 kg/m³, or may be calculated by the computing unit 30 based on the ambient temperature. The acceleration of gravity g may be pre-set to a fixed value, for example 9.8 m/s². In the above Equation (11), 0.5·ρ·Cd·Av²(t) represents the air resistance component of the travel resistance Fdrv. In the above Equation (11), μWg represents the rolling resistance component of the travel resistance Fdrv.

As such, the driving horsepower Pdrv necessary to calculate the energy consumption Etotal_prd_base when traveling on the travel-scheduled road may be calculated using the travel resistance Fdrv. However, the travel resistance Fdrv changes depending on the road surface condition of the travel-scheduled road. For example, when there is a water-related substance such as snow, ice, or water on the surface of the travel-scheduled road, the rolling resistance coefficient u may change. Specifically, when there is a water-related substance on the road surface of the travel-scheduled road, the rolling resistance coefficient u increases because the force to push away the water-related substance present between the road surface and the tires is required during travel of the vehicle C. In other words, when there is a water-related substance on the surface of the travel-scheduled road, the resistance force when the vehicle C is traveling on the road surface increases as compared to when there is no water-related substance on the road surface.

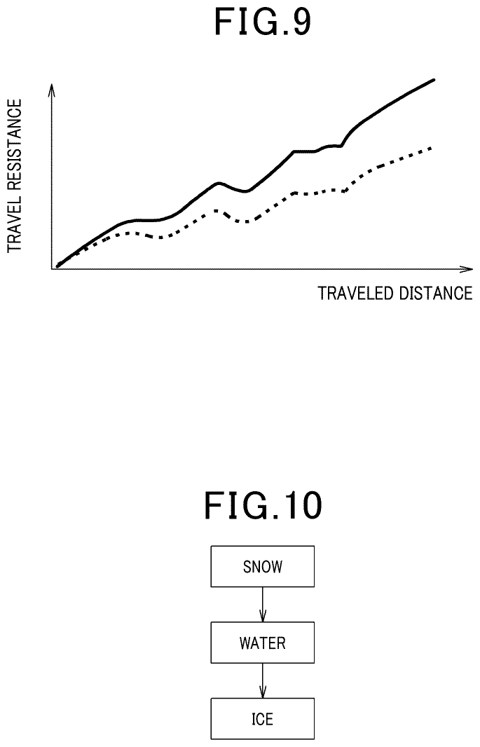

Thus, when there is a water-related substance on the road surface of the travel-scheduled road, the travel resistance Fdrv increases as compared to when there is no water-related substance on the road surface, as illustrated in FIG. 9. An amount of deviation between the travel resistance Fdrv when there is a water-related substance on the surface of the travel-scheduled road and the travel resistance Fdrv when there is no water-related substance on the surface of the road increases as the traveled distance X increases. In FIG. 9, the solid line indicates the correlation between the traveled distance X and the travel resistance Fdrv when there is a water-related substance on the road surface, and the broken line indicates the correlation between the traveled distance X and the travel resistance Fdrv when there is no water-related substance on the road surface.

According to the diligent research of the inventors, the amount of change in travel resistance Fdrv, which changes depending on the presence of the water-related substance, differs according to the type, amount, and state of the water-related substance on the road surface. For example, the amount of change in travel resistance Fdrv varies depending on the road surface condition, which changes depending on the amount of snow on the road surface, the presence of ice that forms when the snow melts and then freezes, and the amount of rainfall on the road surface. The energy consumption varies depending on the amount of change in travel resistance Fdrv.

Thus, when there is a water-related substance on the surface of the travel-scheduled road, when there is assumed to be a water-related substance, or when the energy consumption is calculated without taking into account the water-related substance, there is a risk that errors may occur in calculation results of energy consumption.

Therefore, in the present embodiment, when estimating the energy consumption, the computing unit 30 calculates the provisional travel resistance VFdrv, which is a value of provisional travel resistance to be calculated by the computing unit 30 without taking into account the water-related substance at step S30, as illustrated in FIG. 2. The computing unit 30 calculates the travel resistance Fdrv taking into account the water-related substance at steps S40 and S50, and calculates an estimate of energy consumption based on the calculated travel resistance Fdrv at step S60. Details of steps S30 to S60 will now be described.

At step S30, the computing unit 30 calculates the provisional travel resistance VFdrv using the vehicle characteristics information CI and the travel route information DI acquired at step S10 and step S20 and the above Equation (11). The provisional travel resistance VFdrv is an estimate of provisional resistance that is calculated without taking into account whether there is a water-related substance on the road surface of the travel-scheduled road.

Specifically, in calculating the provisional travel resistance VFdrv, the computing unit 30 uses the gross vehicle weight W, the air resistance coefficient Cd, the front projected area A, and the rolling resistance coefficient u, from the vehicle characteristics information CI acquired at step S10. To calculate the provisional travel resistance VFdrv, the computing unit 30 uses the information on the slope of the travel-scheduled road, the estimated travel speed V at elapsed time t when traveling on the travel-scheduled road, and the estimated acceleration a at elapsed time t when traveling on the travel-scheduled road, from the travel route information DI acquired at step S20. The computing unit 30 calculates the provisional travel resistance VFdrv using these gross vehicle weight W, air resistance coefficient Cd, front projected area A, rolling resistance coefficient u, slope of the travel-scheduled road, travel speed V, acceleration a, the preset air density p and acceleration of gravity g.

Subsequently, at step S40, the computing unit 30 acquires the weather information WI from the storage unit of the server SV as information used to calculate the estimate of energy consumption. The weather information WI includes, as information indicating the state of the atmosphere and various atmosphere phenomena, information on the outside temperature Te indicating a predicted value of the ambient temperature of the subject vehicle when traveling on the vehicle-scheduled road, and information on the sunshine duration Su indicating a predicted value of the sunshine duration on the subject vehicle-scheduled road. The weather information WI further includes a wind speed Ws indicating a predicted value of the wind speed around the subject vehicle when traveling on the vehicle-scheduled road, and information on the predicted weather on the travel-scheduled road. The information on the weather on the travel-scheduled road includes, for example, when the weather is snowy, information on an amount of snowfall Sf, which indicates a predicted amount of snowfall per unit time, and information on a snow depth Sd, which indicates a predicted amount of snow to accumulate at a predefined observation point. The information on the weather condition on the travel-scheduled road includes, for example, when the weather is rainy, information on an amount of rainfall Ra, which indicates a predicted amount of rainfall per unit time. The weather information WI including the information on the amount of snowfall Sf, the information on the snow depth Sd, and the information on the amount of rainfall Ra, is water-related information related to the physical quantities of the water-related substance on the road surface. In addition, the information on the amount of snowfall Sf and the information on the snow depth Sd are snow-related information related to physical quantities of snow on the road surface. Therefore, the communication unit 10 of the present embodiment, which acquires the weather information WI that is information related to the water-related substance, from the server SV, functions as a water information acquisition unit.

The outside temperature Te is set to, for example, 2° C. (degrees Celsius). The sunshine duration Su is set to, for example, 2 hours. The wind speed Ws is set to, for example, 2 m/s. The amount of snowfall Sf is set to, for example, 1 cm/hour or 15 cm/day. The snow depth Sd is set to, for example, 50 cm. The amount of rainfall Ra is set to, for example, 3 mm/hour or 40 mm/day.

The computing unit 30 acquires information on the state of water-related substance necessary for calculating the travel resistance Fdrv based on the acquired weather information WI. The computing unit 30 acquires, as information on the state of water-related substance, for example, a road surface temperature Rte, which is the temperature of the road surface, to estimate which of snow, ice, and water the water-related substance on the road surface of the travel-scheduled road includes. The reason why the road surface temperature Rte is necessary as information on the state of water-related substance is that the state of water-related substance on the road surface changes variously based on the road surface temperature Rte.

For example, even in the situation where it is snowing on the road surface, if it is envisioned that the road surface temperature Rte remains at or above 0° C. for longer than the time required for snow to melt, the snow that has accumulated on the road surface will melt and become water, as illustrated in FIG. 10. Even in the situation where snow has melted to become water, if it is envisioned that the road surface temperature Rte remains below 0° C. for longer than the time required for the water to freeze, the melted snow on the road surface will transition from water to ice, as illustrated in FIG. 10.

In addition, after occurrence of rainfall or snowfall during the daytime with the road surface temperature Rte at or above 0° C., when the road surface temperature Rte drops below 0° C. in an environment where the outside air temperature Te is likely to become relatively low at night or the like, the snow or water on the road surface will freeze to become ice.

In this way, the state of the water-related substance changes as the road surface temperature Rte changes. The water-related substance on the road surface may exist in one of the states of snow, ice and water, or in a mixture of various ratios, depending on the various environmental conditions around the road surface. For example, if snow falls on ice made from snow or water on the road surface, a stack of layers of ice and snow will be formed, in order of proximity to the road surface.

The computing unit 30 of the present embodiment acquires the road surface temperature Rte, which causes the state of the water-related substance to transition, based on the weather information WI as information on the state of the water-related substance necessary to calculate the travel resistance Fdrv.

The road surface temperature Rte is affected by the outside temperature Te, sunshine duration Su, rainfall Ra, snowfall Sf, snow depth Sd, wind speed Ws, traffic volume Rt, traffic flow speed Rs, road surface type Rk, and other factors. For example, the lower the outside temperature Te, the lower the road surface temperature Rte. The road surface temperature Rte tends to be lower the shorter the sunshine duration Su is, the higher the rainfall Ra or snowfall Sf is, and the deeper the snow depth Sd is. The road surface temperature Rte tends to be lower the higher the wind speed Ws, the smaller the traffic volume Rt, and the lower the traffic flow speed Rs. Furthermore, the road surface of the travel-scheduled road has a different heat storage capacity depending on the material covering the road surface, as well as different amount of snow or rain accumulation when snow or rain accumulates on the road surface due to changes in the shape of ruts caused by aging of the road surface. Thus, the road surface temperature Rte during snowfall or rainfall may vary depending on the road surface type Rk.

The reason why the road surface temperature Rte is becomes lower as the traffic volume Rt decreases is that the larger the traffic volume Rt, the less heat (e.g., heat dissipation from internal combustion engine vehicles, exhaust, heat from tires, etc.) causing the road surface temperature Rte to increase is dissipated from other vehicles.

Therefore, in the present embodiment, the computing unit 30 calculates the road surface temperature Rte based on the travel route information DI and weather information WI using the following Equation (12).

$$Rte = f ( Te , var ⊂ / = \{ Su , Ra , Sf , Sd , Ws , Rt , Rs , Rk \} ) \qquad ( 12 )$$

As expressed in Equation (12), the road surface temperature Rte is calculated as a function f of the following variables: the outside air temperature Te, sunshine duration Su, amount of rainfall Ra, amount of snowfall Sf, snow depth Sd, wind speed Ws, traffic volume Rt, traffic flow speed Rs, and road surface type Rk. The part to the right of the “⊂/=” in Equation (12) may include one or more of the sunshine duration Su, amount of rainfall Ra, amount of snowfall Sf, snow depth S, wind speed Ws, traffic volume Rt, traffic flow speed Rs, and road surface type Rk, or all of these variables, or the empty set that includes none of these variables.

That is, the road surface temperature Rte may be calculated based only on the outside temperature Te. In an alternative, the road surface temperature Rte may be calculated based on the outside temperature Te, as well as one or more of the sunshine duration Su, amount of rainfall Ra, amount of snowfall Sf, snow depth Sd, wind speed Ws, traffic volume Rt, traffic flow speed Rs, and road surface type Rk, or all of these variables.

The computing unit 30 then detects the state of the water-related substance on the road surface based on the calculated road surface temperature Rte.

At step S50, the computing unit 30 calculates an amount of increase in resistance Fup, which is an amount by which the travel resistance Fdrv is increased by the presence of water-related substance on the surface of the travel-scheduled road, using the following Equation (13).

$$Fup = uWg ▪ Hresistance \qquad ( 13 )$$

In Equation (13), Hresistance is a predefined coefficient that is pre-set to calculate the amount of increase in resistance Fup, and is set to a value greater than 1.0. The water resistance coefficient Hresistance is set according to the state of the water-related substance on the road surface.

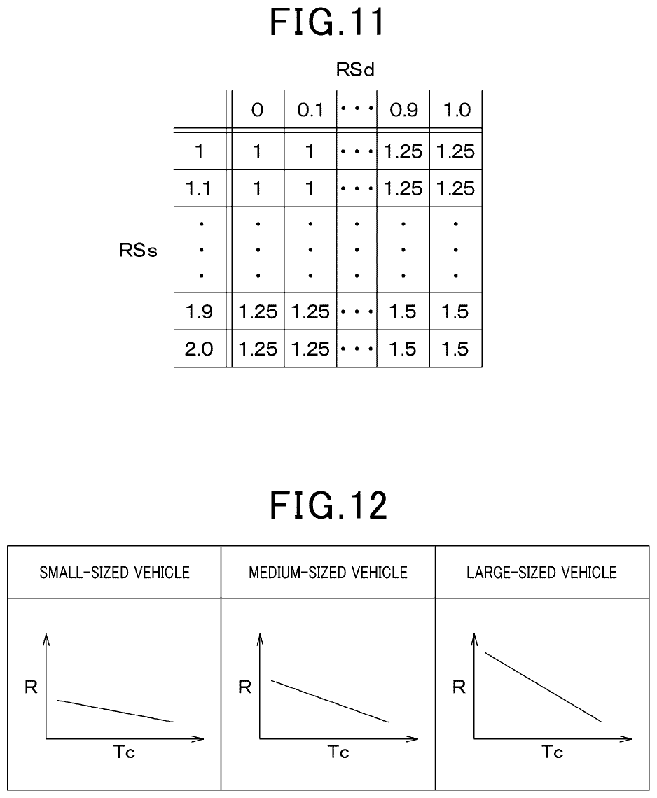

When the state of the water-related substance on the road surface is snow, the water resistance coefficient Hresistance is set based on a two-dimensional map determined by the road surface snow depth RSd and snow density R s as illustrated in FIG. 11. The road surface snow depth RSd indicates a predicted amount of snow accumulated on the road surface of the travel-scheduled road. The snow density RSs indicates a predicted mass per unit volume of snow accumulated on the road surface of the travel-scheduled road.

The road surface snow depth RSd may be calculated, for example, based on the amount of snowfall Sf and the snow depth Sd included in the weather information WI, and the calculated road surface temperature Rte. The snow density RSs may be calculated based on the amount of snowfall Sf and snow depth Sd included in the weather information WI, the calculated road surface snow depth RSd, the road surface temperature Rte, the traffic volume RT, the traffic flow speed RS, and the road surface type RK included in the travel route information DI.

When the road surface snow depth RSd is 0.1 m and the snow density RSs is 190 kg/m³, the water resistance coefficient Hr is set to 1.25 based on the two-dimensional map as illustrated in FIG. 11.

When the state of the water-related substance on the road surface is ice, the water resistance coefficient Hresistance is set based on a two-dimensional map determined by the amount of rainfall Ra and outside temperature Te, although not shown.

When the state of the water-related substance on the road surface is water, the water resistance coefficient Hresistance is set based on a corresponding map that indicates the correlation between the amount of rainfall Ra and the water resistance coefficient Hresistance, although not shown.

At step S60, the computing unit 30 calculates the travel resistance Fdrv when the water-related substance is present on the road surface of the travel-scheduled road, using the following Equation (14).

$$Fdrv ( t ) = Wa ( t ) + 0.5 ▪ρ▪ Cd ▪ {Av}^{2} ( t ) + u W g + Wg sin θ ( t ) + F u p ( t ) \qquad ( 14 )$$

In this manner, the travel resistance Fdrv in the presence of a water-related substance on the road surface of the travel-scheduled road may be calculated based on the vehicle characteristics information CI, the travel route information DI, and the weather information WI. At step S70, the computing unit 30 calculates the estimate of energy consumption using the calculated travel resistance Fdrv. Specifically, in the case of the subject vehicle being an electric vehicle, the calculated travel resistance Fdrv and Equations (1) to (5) are used to calculate the estimate of energy consumption. In the case of the subject vehicle being an engine vehicle, the calculated travel resistance Fdrv and Equations (6) to (9) are used to calculate the estimate of energy consumption.

By the way, when there is snow on the road surface of the travel-scheduled road, a force is required to squash the snow present between the road surface and the tires. The force exerted to squash the snow is a factor that causes the travel resistance Fdrv to increase. Therefore, when there is snow on the road surface of the travel-scheduled road, the energy consumption estimation device 1 may calculate the estimate of energy consumption by further taking into account an increase in travel resistance Fdrv caused by the force exerted to squash the snow. Hereinafter, the amount of increase in travel resistance Fdrv caused by the force exerted to squash snow is also referred to as the amount of increase in travel resistance due to snow squash, Fsup.

The computing unit 30 calculates the travel resistance Fdrv when there is snow on the road surface of the travel-scheduled road, using the following Equation (15).

$$Fdrv ( t ) = Wa ( t ) + 0.5 ▪ρ▪ Cd ▪ {Av}^{2} ( t ) + u W g + Wg sin θ ( t ) + Fu p ( t ) + F s u p ( t ) \qquad ( 15 )$$

The amount of increase in travel resistance due to snow squash, Fsup, is determined by the gross vehicle weight W, the pressure applied by the tires when squashing the snow, and the snow resistance R, which is the resistance offered by the snow when squashing it. The amount of increase due to snow squash, Fsup, increases as the snow resistance R increases. The snow resistance R increases as the snow density RSs decreases. Thus, the amount of increase in travel resistance due to snow squash, Fsup, increases as the snow density RSs decreases.

Therefore, the amount of increase in travel resistance due to snow squash, Fsup, may be determined based on a correlation map based on the snow resistance Rs and the snow density Rs.

The snow resistance R varies according to the pressure applied when the tires squash the snow. The pressure applied when the tires squash the snow is determined by the gross vehicle weight W and the tire contact area Tc, which are included in the vehicle characteristics information CI. The gross vehicle weight W and the tire contact area Tc vary for each vehicle C. For example, the pressure generated when the tires squash the snow increases as the gross vehicle weight W included in the vehicle characteristics information CI increases, and also increases as the tire contact area Tc included in the vehicle characteristics information CI increases.

Here, the gross vehicle weight W and the tire contact area Tc may be roughly classified according to the type of vehicle. For example, vehicles with a higher gross vehicle weight tend to have larger tires with a larger outer diameter and a larger tire width, which leads to a larger tire contact area Tc. On the other hand, vehicles with a lower gross vehicle weight tend to have smaller tires with a smaller outer diameter and a smaller tire width, which leads to a smaller tire contact area Tc. Thus, the gross vehicle weight W and the tire contact area Tc may be roughly classified according to the size of the vehicle C.

Therefore, as illustrated in FIG. 12, the computing unit 30 of the present embodiment has three correlation maps based on the snow resistance R and the snow density RSs. These maps are predetermined according to the size of the subject vehicle. Specifically, there are three types of correlation maps: one for large-sized vehicles with relatively high gross vehicle weight W and relatively large tire contact area Tc, one for small-sized vehicles with relatively low gross vehicle weight W and relatively small tire contact area Tc, and one for medium-sized vehicles with standard gross vehicle weight W and standard tire contact area Tc. As illustrated in FIG. 12, the correlation maps have different slopes according to small-sized, medium-sized, and large-sized vehicles, so that the larger the tire contact area Tc, the higher the snow resistance R for the same snow density RSs.

Based on the vehicle characteristics information CI, the computing unit 30 determines whether the subject vehicle C for which the energy consumption is to be calculated is a small-sized vehicle, a medium-sized vehicle, or a large-sized vehicle. The computing unit 30 then calculates the amount of increase in travel resistance due to snow squash, Fsup, based on the correlation map according to the determined type of vehicle C. This allows the energy consumption estimation device 1 to estimate the energy consumption by taking into account changes in travel resistance Fdrv caused by the force exerted to squash the snow.

As described above, the energy consumption estimation device 1 of the present embodiment includes the communication unit 10 that acquires the weather information WI, which is information related to water-related substances on the road surface, and the computing unit 30 that estimates the energy consumption of the vehicle when traveling on the road surface based on the weather information WI acquired by the communication unit 10.

By the way, when there is a water-related substance on the road surface, the resistance when the vehicle C travels on the road surface becomes higher than when there is no water-related substance on the road surface. Thus, when there is a water-related substance on the road surface, the energy consumption varies more than when there is no water-related substance on the road surface.

The computing unit 30 estimates the energy consumption based on the weather information WI that is information related to water-related substances, which enables suppression of calculation errors in energy consumption caused by the presence of water-related substances. Therefore, the energy consumption estimation device 1 is capable of accurately calculating the energy consumption.

The above embodiment provides the following advantages.

(1) In the above embodiment, the computing unit 30 estimates the travel resistance Fdrv based on the weather information WI and estimates the energy consumption based on the estimated travel resistance Fdrv.

According to the diligent research of the inventors, the travel resistance Fdrv changes due to the presence of water-related substances on the road surface. Changes in travel resistance Fdrv cause changes in energy consumption of the vehicle C.

By contrast, the computing unit 30 estimates the travel resistance Fdrv based on the weather information WI, thereby enabling the accurate calculation of the travel resistance Fdrv even when the travel resistance Fdrv has changed due to the presence of water-related substances. The computing unit 30 calculates the energy consumption accurately based on the accurately calculated travel resistance Fdrv, thereby allowing the energy consumption to be calculated with high accuracy.

(2) In the above embodiment, the computing unit 30 estimates the travel resistance Fdrv based on weather-related information and estimates the energy consumption based on the estimated travel resistance Fdrv.

According to this configuration, when the weather is rainy, snowy, or other weather that generates water-related substances on the road surface, the travel resistance Fdrv can be calculated accurately by estimating the travel resistance Fdrv based on the weather information that generates water-related substances on the road surface. The computing unit 30 then calculates the energy consumption based on the accurately calculated travel resistance Fdrv, which allows the energy consumption to be calculated with high accuracy.

(3) In the above embodiment, the weather information WI includes snow information, which is information related to snow on the road surface. The computing unit 30 estimates the travel resistance Fdrv based on the snow information and estimates the energy consumption based on the estimated travel resistance Fdrv.

According to the diligent research of the inventors, the amount of change in travel resistance Fdrv varies according to the state of the water-related substance present on the road surface. By contrast, when the state of the water-related substance is snow, estimating the travel resistance Fdrv based on the snow information allows the travel resistance Fdrv according to snow to be calculated with high accuracy. The computing unit 30 then calculates the energy consumption based on the accurately calculated travel resistance Fdrv, which allows the energy consumption to be calculated with high accuracy.

(4) In the above embodiment, the snow information includes information on the road surface snow depth RSd, which is information on the depth of snow on the road surface, and information on the snow density RSs, which is information on the density of snow on the road surface. The computing unit 30 estimates the travel resistance Fdrv based on the information on the road surface snow depth RSd and the information on the snow density RSs, and estimates the energy consumption based on the estimated travel resistance Fdrv.

According to this configuration, estimating the travel resistance Fdrv based on the information on the road surface snow depth RSd and the snow density RSs, which affect the amount of change in the travel resistance Fdrv, allows the travel resistance Fdrv to be calculated with high accuracy. The computing unit 30 then calculates the energy consumption based on the accurately calculated travel resistance Fdrv, which allows the energy consumption to be calculated with high accuracy.

(5) In the above embodiment, the communication unit 10 is provided to acquire the vehicle characteristics information CI. The computing unit 30 estimates the energy consumption based on the vehicle characteristics information CI acquired by the communication unit 10.

According to the diligent research of the inventors, the travel resistance Fdrv varies according to the vehicle characteristics. By contrast, the computing unit 30 estimates the travel resistance Fdrv based on the vehicle characteristics information CI, which allows the travel resistance Fdrv to be calculated with high accuracy. The computing unit 30 then calculates the energy consumption based on the accurately calculated travel resistance Fdrv, which allows the energy consumption to be calculated with high accuracy.

(6) In the above embodiment, the communication unit 10 is provided to acquire the travel route information DI on locations that the vehicle C is scheduled to pass through. The computing unit 30 estimates the energy consumption of the vehicle C traveling on the travel-scheduled road based on the travel route information DI that is acquired by the communication unit 10.

According to this configuration, the computing unit 30 can estimate a prediction of the energy consumption when traveling on the travel-scheduled road.

### OTHER EMBODIMENTS

While the specific embodiment of the present disclosure has been described above, the present disclosure is not limited to the above-described embodiment and may incorporate various modifications.

In the embodiment described above, the energy consumption estimation device 1 is separate from the vehicle C for which the energy consumption is to be estimated, but this embodiment is not limited to this configuration. In an alternative, for example, the energy consumption estimation device 1 may be incorporated within the vehicle C for which the energy consumption is to be estimated, and may be integrated with the vehicle C.

In the embodiment described above, the computing unit 30 acquires the vehicle characteristics information CI from the storage unit 20 of the energy consumption estimation device 1 as information for estimating the energy consumption, but this embodiment is not limited to this configuration. In an alternative, for example, the computing unit 30 may acquire the vehicle characteristics information CI from the vehicle C via the network N.

In the embodiment described above, the energy consumption estimation device 1 estimates the prediction of the energy consumption before the vehicle C travels on the travel-scheduled road, but this embodiment is not limited to this configuration. In an alternative, for example, the energy consumption estimation device 1 may estimate the energy consumption while the vehicle C is traveling on the travel-scheduled road.

In the embodiment described above, the energy consumption estimation device 1 acquires the information on water-related substances on the road surface from the server SV, but this embodiment is not limited to this configuration. In an alternative, for example, the energy consumption estimation device 1 may acquire the information on water-related substances on the road surface from surroundings monitoring sensors of the sensors C20, which detect objects around the vehicle C.

It is needless to say that the elements constituting the above embodiments are not necessarily essential unless explicitly stated as essential or obviously considered essential in principle.

In addition, when a numerical value such as the number, value, amount, or range of a component(s) of any of the above-described embodiments is mentioned, it is not limited to the specific number or value unless expressly stated otherwise or it is obviously limited to the specific number or value in principle, etc.

When the shape, positional relationship, or the like of a component(s) or the like of any of the embodiments is mentioned, it is not limited to the specific shape, positional relationship, or the like unless explicitly stated otherwise or it is limited to the specific shape, positional relationship, or the like in principle, etc.

The computing unit 30 and the methods thereof described in the present disclosure may be realized by a dedicated computer provided by configuring a processor and memory programmed to perform one or more functions embodied in a computer program. Alternatively, the computing unit 30 and the method thereof described in the present disclosure may be realized by a dedicated computer provided by configuring a processor with one or more dedicated hardware logic circuits. Alternatively, the computing unit 30 and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer.

What is claimed is:

1. An energy consumption estimation device for estimating energy consumption of a vehicle that travels on a road surface, comprising:
a water information acquisition unit configured to acquire water-related information on a water-related substance on the road surface; and
an energy estimation unit configured to estimate the energy consumption of the vehicle that travels on the road surface based on the water-related information acquired by the water information acquisition unit.

2. The energy consumption estimation device according to claim 1, wherein
the energy estimation unit is configured to estimate a travel resistance based on the water-related information, the travel resistance being a resistance component when the vehicle travels on the road surface, and estimate the energy consumption based on the estimated travel resistance.

3. The energy consumption estimation device according to claim 2, wherein
the water-related information includes weather information on weather, and
the energy estimation unit is configured to estimate the travel resistance based on the weather information and estimate the energy consumption based on the estimated travel resistance.

4. The energy consumption estimation device according to claim 3, wherein
the weather information includes snow information that is information related to snow on the road surface, and
the energy estimation unit is configured to estimate the travel resistance based on the snow information and estimate the energy consumption based on the estimated travel resistance.

5. The energy consumption estimation device according to claim 4, wherein
the snow information includes snow depth information that is information on a depth of snow accumulated on the road surface, and snow density information that is information on a density of snow accumulated on the road surface, and
the energy estimation unit is configured to estimate the travel resistance based on the snow depth information and the snow density information and estimate the energy consumption based on the estimated travel resistance.

6. The energy consumption estimation device according to claim 2, further comprising
a vehicle information acquisition unit configured to acquire vehicle characteristics information related to characteristics of the vehicle that cause the travel resistance to change, wherein
the energy estimation unit is configured to estimate the energy consumption based on the vehicle characteristics information acquired by the vehicle information acquisition unit.

7. The energy consumption estimation device according to claim 1, further comprising
a location information acquisition unit configured to acquire scheduled location information on locations that the vehicle is scheduled to pass through, wherein
the energy estimation unit is configured to estimate the energy consumption of the vehicle scheduled to pass through the locations based on the scheduled location information acquired by the location information acquisition unit.

8. An energy consumption estimation method for estimating energy consumption of a vehicle that travels on a road surface, comprising:
acquiring water-related information on a water-related substance on the road surface; and
estimating the energy consumption of the vehicle that travels on the road surface based on the acquired water-related information.

9. A non-transitory computer readable medium having stored thereon instructions executable by a computer to cause the computer to perform an energy consumption estimation method for estimating energy consumption of a vehicle that travels on a road surface, the energy consumption estimation method comprising:
acquiring water-related information on a water-related substance on the road surface; and
estimating the energy consumption of the vehicle that travels on the road surface based on the acquired water-related information.
